(19) United States
(12) Patent Application Publication
(10) Pub. No.: US 2006/0077614 A1
(43) Pub. Date: Apr. 13, 2006

(54) Repeater with selective repeat

(76) Inventors: Damon Bruccoleri, Long Branch, NJ (US); Michael Ostrovsky, Brooklyn, NY (US); Raymond Szekretar, Plainview, NY (US); Alfred J. Lombardi, Syosset, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/118,367

(22) Filed: May 2, 2005

Related U.S. Application Data
(60) Provisional application No. 60/568,548, filed on May 6, 2004.

(51) Int. Cl. H02H 9/06

(52) U.S. Cl. 361/119

(57) ABSTRACT

A repeater in a power line control system includes a selective repeat feature. The repeater stores selected codes associated with a particular location. When a command is received on an input power line, the repeater repeats only those commands that have the selected codes. Implementations of the repeater include a test switch that, when activated, send command signals to activate and deactivate electrical devices in the power line communication system. A noise level indicator can be included to indicate a noise level on the input power line that can disable commands transmitted to an electrical device in the power line communication system.

This application claims the benefit of the filing date of a provisional application having Ser. No. 60/568,548, which was filed on May 6, 2004.

### BACKGROUND OF THE INVENTION

1. Field of the Invention

The present invention generally relates to power line communication systems.

2. Description of the Related Art

A power line communication system, such as a system based on the X10 standard, uses a power line as a carrier medium for communication between electrical devices. In a typical residential setting, such as a home, the power line can include an alternating current (AC) power source from a standard 60 Hz distribution line providing a domestic electric power source of 120V/240V at a maximum of 200 amperes for normal use. The power line in a home is derived from an AC power source at a step-down transformer provided by an electric utility company. The AC power source is shared with other homes in a neighborhood. Some neighborhoods with large homes may have fewer than 3 homes sharing the AC power source from the step-down transformer, whereas a condominium complex or a townhouse community may have upwards of 10 homes sharing the same transformer.

Power line communication systems are bandwidth limited and susceptible to noise. To improve noise immunity, power line communication protocols tend to operate at a slow rate compared to radio-frequency (RF) or wired techniques. As power line communication systems increase in popularity and more homes share the AC power line, noise immunity and bandwidth may decrease further.

In a power line communication system, each home may be assigned a unique code in a technique referred to as Coded Access. A master electrical device, such as a central controller, can send a command signal over a power line to a slave electrical device such as a wall switch connected to a lamp. The command signal can include an instruction to operate a slave device. For example, the instruction can cause a device to turn ON or OFF. Each command signal can include a unique code to identify a slave device and a home in which the slave device is installed. When a command signal with the unique code is sent over the power line of the home, only the slave device with a code that matches the unique code responds to the command signal. However, command signals that are not relevant to the home still travel over the home's power line. The bandwidth, which is a measure of the power line's ability to carry signals, can become congested with commands for neighbor's houses. That is, the power line of the house has a limited capacity to carry command signals and some of that capacity is occupied by extraneous commands.

Various approaches may be employed to improve usage of the bandwidth. One solution includes installing an electrical device called a repeater at the service panel of a home. The repeater amplifies and repeats all command signals it receives including command signals from other homes that are not relevant. While this technique can improve the response of the system to weak signals, the bandwidth usage may not be improved. Another solution entails connecting a filter at the service panel of a home so to isolate the power line in that home from the power line of other homes in a neighborhood. However, these filters can be expensive and bulky to install.

A typical slave device in a power line communication system is a switch device that responds to command signals for connecting power to a load such as an electronic ballast transformer in a lamp. Command signals have a frequency that is often substantially higher than the 60 Hz of the power applied to the load. When a particular switch is turned ON and power is applied to the electronic ballast, an attenuation of command signals may occur. As a result, a slave switch may not receive a command signal causing it to fail to operate.

### SUMMARY OF THE INVENTION

The present invention provides a repeater device that can receive command signals over a power line system at a step-down transformer and repeat the command signals having a code that matches selected codes to a second power line system at a home. The present invention also can provide a switch device having filtering capability to present a high impedance to command signals and prevent a load from attenuating the command signals.

The repeater device can have a selective repeat feature that tends to block command signals that are not relevant to a selected home. As a result, the effective bandwidth of a power line communication system in a home may increase. However, this feature does allow a user to select command signals from another home such that the other home can control an electrical device in the user's home. In addition, the selective repeat feature of the repeater device may reduce the likelihood that noise present on the power line communication system (including random noise or noise from a neighbor's home) is interpreted as a command signal because only command signals having a code that matches a code selected by a user is repeated.

An electrical switch device can include a filter circuit, such as an inductor, connected in series between a power source and load to reduce the possibility that a load, such as an electronic ballast, will attenuate a command signal. As a consequence, a switch device or other electrical device may be less likely to fail (e.g., not respond to a command) than without the filter circuit, increasing the reliability of the devices and of a power line communication system.

Other objects and features of the invention will be pointed out in the following description and claims and illustrated in the accompanying drawings, which disclose, by way of example, the principles of the invention, and the best mode, which is presently contemplated for carrying them out.

### BRIEF DESCRIPTION OF THE DRAWINGS

Preferred embodiments of the present application are described herein with reference to the drawings in which similar elements are given similar reference characters, wherein:

FIG. 1 is a block diagram of a repeater device for selectively repeating command signals in a power line communication system;

FIG. 2 is a block diagram of a switch device with filtering capability for use in a power line communication system; and

FIG. 3 is a block diagram of a method for selectively repeating command signals in a power line communication system.

### DETAILED DESCRIPTION OF THE INVENTION

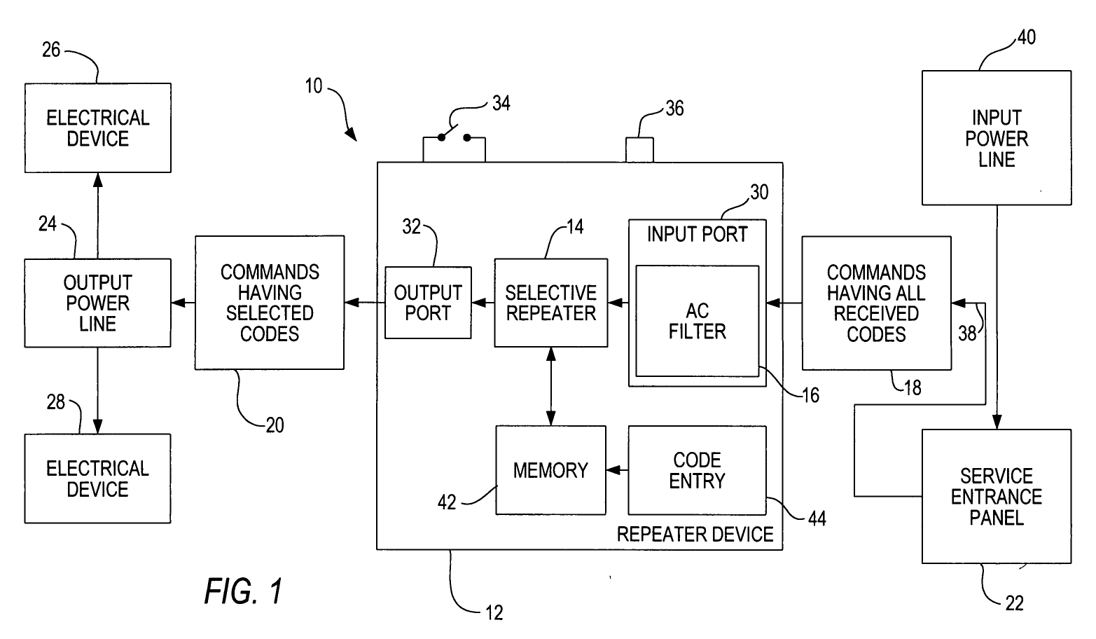

FIG. 1 is a block diagram of a repeater device 12 with the capability to selectively repeat command signals in a power line communication system 10. The repeater device 12 includes a selective repeater 14 to control the operation of electrical devices 26, 28 over an output power line 24 located in a home. The repeater device 12 can include a input port 30 to receive command signals 18 from a power line 38. The selective repeater 14 is coupled to a memory 42 that can store selected device codes associated with electrical devices such as devices 26, 28. The memory 42 is coupled to a code entry device 44 through which the selected device codes are provided to the memory 42. The selective repeater 14 is coupled to an output port 32. The output port 32 couples the output of the selective repeater 14, which are commands having the selected location codes, to an output power line 24. In an implementation, the repeater device 12 can include a test switch 34 for testing some functionality of the repeater device. An indicator 36 also may be coupled to the device to provide indicia of the operation of the repeater device or the communication line system.

Command signals in a power line communications system are provided to an input power line 40. The command signals can be used to control electrical devices in a location such as a house. The input power line may have command signals that are destined for more than one location. The input power line carrying the command signals is received at the service entrance panel 22 of a location. All of the command signals 18 that are on the input power line 40 are received by the service entrance panel 22. However, not all of the received command signals may be associated with electrical devices at the home where the service entrance panel 22 is located. The command signals 18 can include a unique device code assigned to electrical devices 26, 28 and repeater device 12 as well as a location code, that identifies a specific home in which the devices are located. The command signals 18 also can include a command or instruction for controlling the electrical device. In an implementation, the repeater device 12 can include code entry circuitry 44 to enable a user to enter selected location codes that may be stored in memory 42. Selective repeater 14 can retrieve the selected location codes from memory 42. Only those received command signals having a location code that matches the selected codes are repeated through the output port 32 to the output power line 24. Because only selected command signals 20 are repeated, the effective bandwidth of power line 24 is increased.

In an implementation, an AC filter 16 may be included in the input port 30 to filter unwanted signals from power line 38 at service panel 22. Output power line 24 can include, for example, a standard 50 Hz or 60 Hz distribution line providing a domestic electric power source of a nominal 120V/240V and may have a maximum of 200 amperes for normal use. Output power line 24 is derived from power at service panel 22, which may be located in a home where electrical devices 26, 28 are installed.

A switch 34, such as a push-button switch, can be used to initiate one or more functionality tests of repeater device 12. For example, a test can include having repeater device 12 transmit command signals to activate and deactivate electrical devices 26, 28 in power line communication system 10. The repeater device 12 also can include an indicator 36, such as a light emitting diode (LED), for providing an indication of the level of noise present in a power line communication system that can potentially disable electrical device 26, 28.

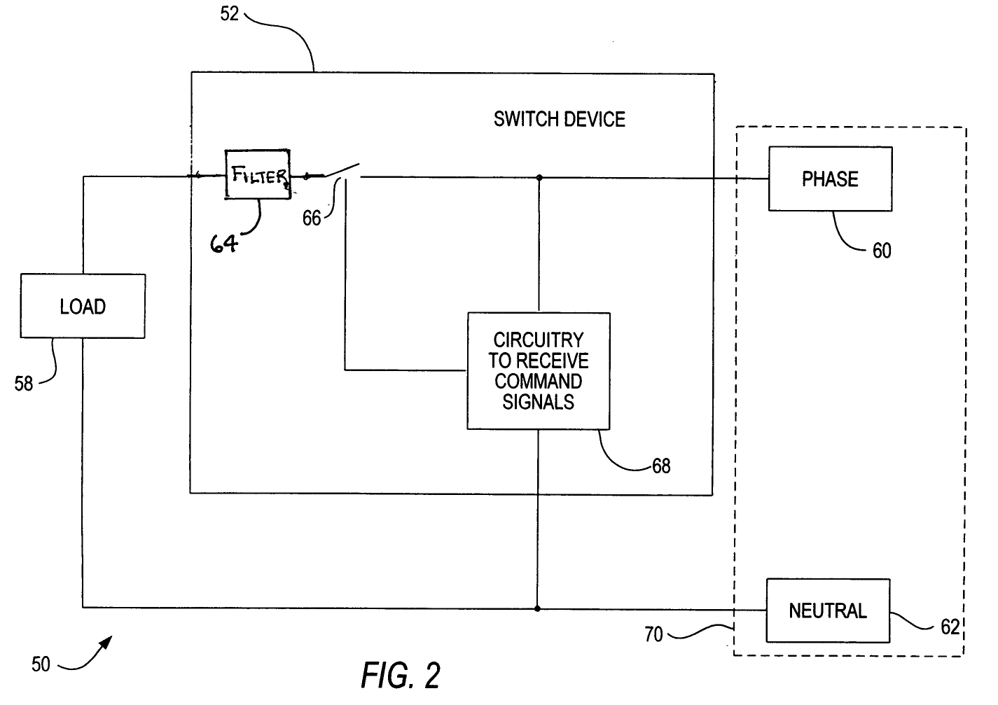

FIG. 2 is a block diagram of a switch device 52 with filtering capability for use in a power line communication system 50. The switch device 52 is a type of electrical device 26, 28 illustrated in FIG. 1. The switch device 52 can receive power from an AC power line 70. The switch device includes circuitry to receive command signals on the AC power line 70 and, in response, provide power to a load 58. The switch device can include filter circuit 64, such as an inductor, in series with the load 58. The filter circuit 64 presents a high impedance to the command signals that have a higher frequency than the frequency of the AC power. Some loads, such as an electronic ballast that can generate a high frequency on the AC power line, can attenuate command signals and compromise the reliability if the command line system. The filter can help to prevent the load 58 from attenuating command signals. The switch device 52 includes control circuit 68 to receive command signals from the AC power line 70 and, in response to the command signals, activate a switch circuit 66, such as a relay, so as to provide an electrical connection path between AC power line 70 and load 58. The AC power line 70 can have phase 60 and neutral 62 conductors.

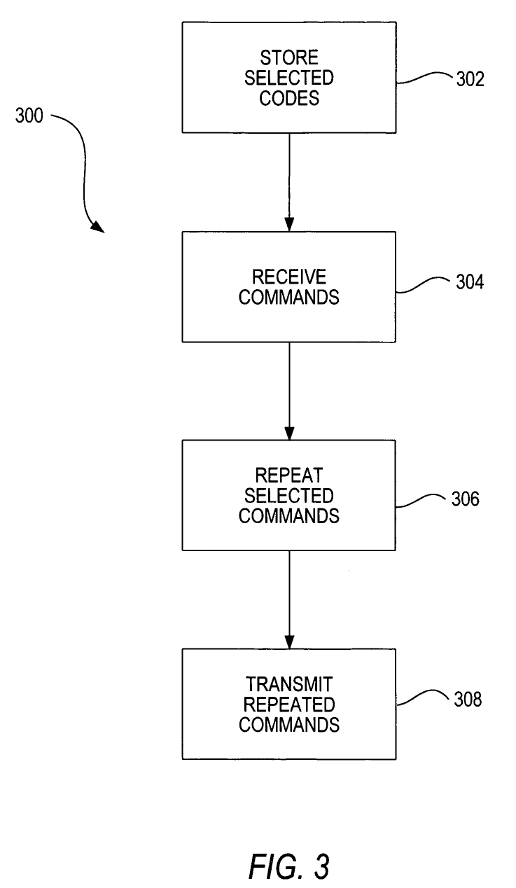

FIG. 3 is a block diagram 300 of a method for repeating selected commands in a power line control system. Each location such as a home may be associated with a respective location code. Codes associated with a selected location may be stored, for example, in an electronic memory, box 302. The selected location codes may be entered manually or electronically into the memory through a code entry device such as a keypad or electronic port. The memory is coupled to a repeater that can repeat received command signals. The location codes represent locations, such as a residence, that has addressable electric devices. A command signal can be received by the repeater from an input power line of the power line control system, box 304. Each command can have an associated location code and instruction for an addressable electrical device. The repeater is responsive to repeat only the received command signals having the selected location codes stored in the memory, box 306. Thus, while many command signals may be received, only those command signals that have the selected location code are repeated. The repeated command signals are transmitted to an output power line of the power line control system, box 308. Addressable electrical devices are couple to the output power line. The electrical devices can receive and respond to the command signals repeated on the output power line.

While there have been shown and described and pointed out the fundamental novel features of the invention as applied to the various embodiments, as is presently contemplated for carrying them out, it will be understood that various omissions and substitutions and changes of the form and details of the device illustrated and in its operation may be made by those skilled in the art, without departing from the spirit of the invention.

What is claimed is:

1. A repeater device of a power line control system comprising:
an input port to receive command signals on an input power line, the commands having a location code representing a location in which an electrical device is installed; and
a repeater coupled to the input port that repeats only those commands having a selected code.

2. The repeater device of claim 1 comprising an output port coupled to the repeater to transmit the repeated commands to an output power line.

3. The device of claim 2 comprising an indicator to indicate a noise level on the input power line that can disable commands transmitted to an electrical device present on the output power line in the power line communication system.

4. The repeater device of claim 2 comprising a code entry circuit coupled to the repeater to enable entry of the selected codes into a memory.

5. The repeater device of claim 1 comprising an alternating current (AC) filter coupled to the input power line to filter unwanted signals from the input power line.

6. The device of claim 1 comprising a switch coupled to the repeater to initiate a test including sending command signals to activate and deactivate electrical devices in a power line communication system.

7. A repeater device for selectively repeating command signals in a power line communication system, the repeater device comprising:
an input port to receive command signals for controlling electrical devices in a power line communication system, each command signal having a location code representing a location in which an electrical device is installed,
a code entry circuit to enable a user to select one or more location codes; and
an output port to transmit command signals having a location code that matches the selected code.

8. The device of claim 7, further comprising an alternating current (AC) filter coupled at the input port for filtering unwanted signals from a power line communication system.

9. The device of claim 7, comprising a switch for initiating a test including sending command signals to activate and deactivate electrical devices in a power line communication system.

10. The device of claim 7, comprising an indicator for providing an indication of the noise level present in a power line communication system that can potentially disable an electrical device.

11. The device of claim 7, further comprising an indicator for providing an indication of the status of electrical devices in a power line communication system.

12. A switch device having filtering capability for use in a power line communication system, the switch device comprising:
a switch circuit connected between an input port and an output port, wherein the output port is for connecting to a load, and the input port is for connecting a power source to power the load and for receiving command signals for controlling power to the load;
a repeater having a first end coupled to the input port and a second end coupled to the switch circuit, wherein the repeater responds to the command signals and activates the switch circuit to provide an electrical connection path between the power source and the load; and
a filter circuit connected in series between the switch circuit and the load, wherein the filter circuit presents a high impedance to the command signals to prevent the load from attenuating the command signals.

13. The device of claim 12, wherein the switch circuit includes a relay.

14. The device of claim 12, wherein the filter circuit includes an inductor.

15. A method of improving noise immunity in a power line control system comprising:
storing in an electronic memory selected codes representing locations of electrical devices on the power line control system;
receiving commands having location codes from an input power line of the power line control system; and
repeating only the received commands having the selected location codes.

16. The method of claim 15 comprising transmitting the repeated commands to an output power line of the power line control system.

17. The method of claim 16 comprising indicating a noise level on the input power line that can disable commands transmitted to an electrical device present in the power line communication system.

18. The method of claim 15 comprising enabling a user to enter the selected codes into the electronic memory.

19. The method of claim 15 comprising filtering the input power line of unwanted signals.

20. The method of claim 15 comprising testing the power line control system by sending command signals to activate and deactivate electrical devices in the power line communication system.
